(19) United States
(12) Patent Application Publication
(10) Pub. No.: US 2021/0170603 A1
(43) Pub. Date: Jun. 10, 2021

(54) METHOD FOR USING A MULTI-LINK ACTUATED MECHANISM, PREFERABLY A ROBOT, PARTICULARLY PREFERABLY AN ARTICULATED ROBOT, BY A USER BY MEANS OF A MOBILE DISPLAY APPARATUS

(71) Applicant: YUANDA ROBOTICS GMBH, Hannover (DE)

(72) Inventors: Jens KOTLARSKI, Gehrden (DE); Andreas SCHOOB, Hannover (DE); Christian GRETT, Hemmington (DE)

(73) Assignee: YUANDA ROBOTICS GMBH, Hannover (DE)

(21) Appl. No.: 17/048,199

(22) PCT Filed: Apr. 8, 2019
(86) PCT No.: PCT/EP2019/058852

§ 371 Date: Oct. 16, 2020

(30) Foreign Application Priority Data
Apr. 19, 2018 (DE) 10 2018 109 463.9

(51) Int. Cl. B25J 9/16; B25J 13/08; B25J 13/00

(52) U.S. Cl. CPC B25J 9/1697; B25J 9/161; B25J 13/006; B25J 13/088; B25J 9/1666

(57) ABSTRACT

A method at least including the steps of aligning an image capturing element of a mobile display apparatus on a multi-link actuated mechanism by a user, capturing at least the multi-link actuated mechanism by means of the image capturing element of the mobile display apparatus, identifying the multi-link actuated mechanism in the captured image data of the image capturing element of the mobile display apparatus, indicating in three dimensions the multi-link actuated mechanism on the basis of the captured image data together with the depth information items, and overlaying the virtual representation of the multi-link actuated mechanism on the multi-link actuated mechanism in the display element of the mobile display apparatus, wherein the overlay is implemented taking account of the geometric relationships of the multi-link actuated mechanism.

The present invention relates to a method for the use, by a user, of a multi-link actuated mechanism, preferably a robot, particularly preferably an articulated robot, by means of a mobile display apparatus, according to claim 1, to a system for carrying out a method of this kind according to claim 15, to a mobile display apparatus for carrying out a method of this kind according to claim 16, to a multi-link actuated mechanism for carrying out a method of this kind according to claim 17, and to a computer program product comprising a program code for carrying out a method of this kind according to claim 18.

Robots have long been used as technical apparatus to relieve humans of mechanical work. Robots are now used in many different fields. In industry, for instance, in particular articulated robots are widely used to take care of tasks in particular in assembly, manufacturing, logistics, packing and commissioning. An articulated robot is typically a 6-axis machine having a cubic working space, meaning that articulated robots can be used very flexibly. The tool that acts as the end effector can be changed depending on the application. Moreover, the programming of the articulated robot can be adapted to the application. The articulated robot itself, however, can be used in unchanged form, which can make it very adaptable.

In the last few years, robots, and in particular articulated robots, have been developed to work together with humans for assembly, for example. This has resulted in the term “collaborative robot” or “cobot.” It is possible to do away with mechanical demarcations, e.g. grille partitions, which were normally used to separate the working space of the robot from the surrounding region in which people could stand safely, and light barriers, light curtains and the like, which at least make it possible to see when a person has entered the working space of the robot. Instead, people can move around the robot freely.

To program an application, for example positions and orientations (collectively also referred to as poses), paths and their speeds (collectively also referred to as trajectories), and actions, e.g., of the end effector, such as opening and closing, normally have to be specified by a user. From this, entire sequences of movements can be created for transferring the end effector from a start pose to a target pose either directly or via at least one intermediate pose therebetween. If the end effector, for example in the form of a gripper, is involved in this movement, an item, for instance, can be gripped at the start pose and set down at the target pose. This kind of sequence of movement and action of the gripper can be referred to as an application, which in this case can be referred to as a “picking and placing” application.

Initially, applications in the form of text descriptions were created on a stationary computer acting as a text-based programming interface, and then transmitted to the robot. For this purpose, the coordinates of the individual axes for each pose could be input using a keyboard, and actions, speeds and the like could be specified by further commands. This was usually done independently of the robot. The disadvantage of this type of programming of robots is that the transfer procedure for deriving a movement or action of the robot from the written description must be done in the user's mind. This type of robot programming can be slow and/or prone to error. In addition, this mental transfer procedure between a text-based program and an actual robot configuration or actual robot surroundings can sometimes be very challenging for the user. This process is not very intuitive, either.

To improve the options for programming robots, the robots have been developed further such that today the programming can also be done using handheld devices, which a person (as the user) holds in one hand and operates using the other hand. In this case, the person can stand in the immediate vicinity of the robot, watch it with their own eyes and move together with the movements of the robot in order to carry out or check the programming. This can increase the user's understanding of their programming. In this case too, however, the programming is still normally in the form of text descriptions that have just been relocated from a remote stationary computer onto the handheld device in the immediate vicinity of the robot being programmed.

To make the programming of robots simpler, quicker and/or more intuitive, particularly in industrial production, approaches for carrying out the programming within a virtual environment or a virtual reality have now become known. Virtual reality (VR) refers to the representation and simultaneous perception of reality and its physical properties in an interactive virtual environment generated in real time by a computer. In the VR environment, a model of the robot being programmed can be displayed and programmed. The result of the programming can also be simulated by a virtual representation of the movements and actions in order to identify errors. The successful result of the virtual programming can then be transmitted to and applied on an actual robot.

The user can carry out the programming in the VR environment by the user themselves taking part in the virtual environment; this is called immersive virtual reality. Immersion describes the effect that is caused by a virtual reality environment and which forces the user's awareness that they are being exposed to illusory stimuli so far into the background that they perceive the virtual environment to be real, When the degree of immersion is particularly high, this is also referred to as presence. A virtual environment is deemed immersive when it allows the user to directly interact with it, as a result of which a considerably higher immersion intensity can be achieved than with mere observation.

In this case, the interaction for programming the robot can be implemented, for example, by means of gestures made by the user and depicted in the VR environment. For this purpose, a head-mounted display (HMD) and data gloves can be used. An HMD is a visual output device that is worn on the head and either presents images on a screen close to the eye or projects them directly onto the retina (virtual retinal display). Depending on the configuration, the HMD is also referred to as video glasses or a headset display or VR headset. The data glove is an input device in the form of a glove. Orientation in the virtual space and interaction with the virtual space is brought about by movements of the hand and fingers. The application generally occurs in combination with an HMD.

US 2017 203 438 A1 describes a system and a method for creating an immersive virtual environment using a virtual reality system that receives parameters corresponding to a real-world robot. The real-world robot may be simulated to create a virtual robot on the basis of the received parameters. The immersive virtual environment may be transmitted and visually displayed to a user. The user may supply input and interact with the virtual robot. Feedback such as the current state of the virtual robot or the real-world robot may be provided to the user. The user may program the virtual robot. The real-world robot may be programmed on the basis of the virtual robot training.

In other words, US 2017 203 438 A1 creates an immersive virtual environment using a virtual reality system. A robot visualized therein is based on data on a real-world robot. Within the virtual environment, the virtual robot can be programmed by a person through interactions, and feedback from the virtual robot to the user is also possible. The real-world robot can ultimately be programmed on the basis of the data on the virtual robot.

The disadvantage of this type of robot programming is that the execution of the programming on the real-world robot is highly dependent on the quality of the simulation of the virtual robot and the surroundings thereof. In other words, discrepancies between reality and the virtual environment can result from the fact that the robot has to be transmitted into the virtual reality; discrepancies in this respect can have an impact on programming, and so the programming may be successful in the virtual environment but not in reality. Moreover, creating the virtual environment, and in particular the virtual robot, requires considerable work.

The link between the real-world environment and the virtual environment is represented by “augmented reality” (AR), which is understood as the computer-assisted expansion of the perception of reality. This information can address all human sensory modalities. Frequently, though, augmented reality is only understood as the visual display of information, i.e. the addition of computer-generated additional information or virtual objects to images or videos by means of overlaying or superimposition. Unlike virtual reality, in which the user is fully immersed in a virtual world, augmented reality focuses on the display of additional information in the real-world environment. For this purpose, e.g. mixed-reality glasses can be used, which the user can see through such that they can perceive the real-world environment unhindered. Image elements can be generated and overlaid in the field of view of the user, such that these image elements can be perceived by the user together with the real-world environment. In other words, virtual objects can be overlaid in the real-world environment such that the user can perceive these both together.

Robots can thus be programmed in an augmented reality such that the real-world robot being programmed is viewed through mixed-reality glasses, for example. Command options and information can be overlaid as virtual objects, which the user can select using gestures. The result of the programming can be checked by the user directly on the real-world robot in that the real-world robot executes the application and is watched by the user as it does so. Through the use of gestures specifically, this can be a very simple, quick and/or intuitive way of programming a real-world robot.

US 2013 073 092 A1 describes a system for operating a robot, including a substantially transparent display configured such that an operator can see a portion of the robot and data and/or graphical information associated with the operation of a robot. Preferably, a controller in communication with both the robot and the transparent display is configured to allow the operator to control the operation of the robot.

The disadvantage of programming robots in the manner known hitherto in an augmented reality is that the augmented reality is often overloaded with virtual objects. The plethora of overlaid virtual objects overloads the real-world environment and can confuse and distract the user rather than assisting them, so previously known implementations of an augmented reality are rather unhelpful for programming robots. The plethora of information and the virtual objects, some of which are very large, colorful and conspicuous, can seem fanciful rather than pertinent.

These kinds of considerations also play a role in automation systems, which are similar to the robots in terms of the mobility of the driven links relative to one another and can be used for similar tasks. Together, automation systems and robots, and in particular articulated robots, can be referred to as drive systems or multi-link actuated mechanisms.

The object of the present invention is to provide a method for using a multi-link actuated mechanism, preferably a robot, particularly preferably an articulated robot, of the type described at the outset in such a way that the use is made simpler, quicker, more convenient and/or more intuitive for the user. This is to be made possible in particular for commissioning and/or programming. At least one alternative to the known methods of this kind is to be provided.

According to the invention, this object is achieved by a method having the features of claim 1, a system having the features of claim 15, a mobile display apparatus having the features of claim 16, a multi-link actuated mechanism having the features of claim 17 and a computer program product having the features of claim 18. The dependent claims describe advantageous developments.

The present invention thus relates to a method for the use, by a user, of a multi-link actuated mechanism, preferably a robot, particularly preferably an articulated robot, by means of a mobile display apparatus. A mechanism of this kind can either be arranged in a stationary manner or be mobile. The articulated robot is preferably a cobot. The mechanism can also be an automation system. A “use” should be understood in particular to mean the commissioning, programming and operation. A user is a person that executes a use.

The multi-link actuated mechanism comprises at least a plurality of links interconnected by actuated joints, and an end effector connected to at least one link. A mechanism of this kind can either be arranged in a stationary manner or be mobile. The articulated robot is preferably a cobot. The mechanism can also be an automation system.

The multi-link actuated mechanism comprises a plurality of links interconnected by actuated joints, a base arranged in a stationary manner relative to the links and connected to a first link by a first actuated joint, and an end effector connected to a link by an actuated joint.

A link can be understood to be a rigid element that is connected by at least one joint at each end to the base, to a further link or to the end effector of the mechanism. A base can also be provided, arranged in a stationary mariner relative to the links such that all movements of the links and the end effector occur relative to the base. The base itself can be movable. The end effector can preferably be connected to the closest link by means of an end-effector unit. The end-effector unit can also be connected to the closest link by means of an actuated joint. Between the end-effector unit and the end effector itself, an actuated joint can also be provided in order to rotate the end effector about a common longitudinal axis, in particular with respect to the end-effector unit. Preferably, the mechanism, preferably in the form of a robot and particularly preferably in the form of an articulated robot, extends away from the stationary or mobile base by means of a plurality of links, which are interconnected by actuated joints, and by means of the end-effector unit as far as to the end effector, thus forming a serial kinematic chain.

A joint should be understood to be a movable connection between two elements, such as here between two links, between a link and an end effector or the end-effector unit, between the end-effector unit and the end effector itself, or between a link and the base. This mobility can preferably be rotational or translational, although combined mobility can also be possible. Preferably, the joints are formed as pivot joints. The joints can each be driven, i.e. actuated, by a drive unit; electrical drives are preferred since electrical energy can be transmitted to the relevant drive unit comparatively simply via the individual links and joints. The end effector can be any kind of tool, sensing element and the like, e.g. a gripper and the like. The joints can comprise position sensors, such as angular displacement sensors in pivot joints, in order to capture the angular positions of the joints. In addition, torque sensors can also be provided.

The mobile display apparatus comprises at least one display element designed to display to the user at least one real-world representation of the multi-link actuated mechanism, preferably together with the surroundings thereof, and at least one image capturing element designed to capture the multi-link actuated mechanism, preferably together with the surroundings thereof, as image data together with depth information, the display element further being configured to overlay, for the user, at least one virtual representation of the multi-link actuated mechanism on the real-world representation of the multi-link actuated mechanism, and preferably in the surroundings thereof. The mobile display apparatus can also be referred to as a visualization system.

Any kind of movable apparatus that in particular can be carried by a user and comprises the corresponding elements described above can be used as a mobile display apparatus. In particular, this apparatus may be mixed-reality glasses, augmented-reality glasses, HoloLens, contact lenses or handheld devices with these functions, e.g. tablets or smartphones. A screen, such as in a tablet or smartphone, can be used accordingly as the display element. The display apparatus can, however, also be a completely to largely transparent screen or a corresponding lens of mixed-reality glasses, augmented-reality glasses, a HoloLens or a contact lens, such that the real-world representation of the multi-link actuated mechanism is generated by the user looking through the screen or lens. In a tablet or smartphone, for example, this is implemented by the capture of images of the multi-link actuated mechanism and the rendering thereof on the screen. The image is captured by means of the image capturing element, which can be a two-dimensional sensor in the form of an area scan camera.

The depth information can be captured, for example, by configuring the image capturing element to be stereoscopic. The stereoscopy is the rendering of images with a spatial impression of the depth present in the real-world surroundings. Accordingly, an image capturing unit of this kind can have two area scan cameras which capture their surroundings simultaneously from two viewing angles such that the combination of all their respective captured image data can be used to obtain depth information. in this case, the stereoscopic image capturing element can capture the image data together with depth information, which results from the image data in the two sets of image data captured concurrently by the individual cameras. A time of flight (TOF) camera, which can capture and determine distances using the time of flight method, can also be used as a 3D camera system.

Alternatively or additionally, the image capturing element in the form of just one area scan camera can capture an image of the surroundings without depth information, which can be obtained simultaneously using a further sensor such as an infrared sensor or a depth camera. In this case, the image data can be captured per se and then made available by the image capturing element together with the concurrently captured depth information as combined data.

The method comprises at least the steps of:
orienting, by the user, the image capturing element of the mobile display apparatus towards the multi-link actuated mechanism, preferably together with the surroundings thereof,
capturing at least the multi-link actuated mechanism, preferably together with the surroundings thereof, by means of the image capturing element of the mobile display apparatus,
identifying the multi-link actuated mechanism, and preferably the surroundings thereof, in the captured image data of the image capturing element of the mobile display apparatus,
indicating, in three dimensions, the multi-link actuated mechanism, and preferably the surroundings thereof, on the basis of the captured image data together with the depth information, and
overlaying the virtual representation of the multi-link actuated mechanism, and preferably the surroundings thereof, on the multi-link actuated mechanism in the display element of the mobile display apparatus,

the overlaying being carried out while taking account of the geometric relationships of the multi-link actuated mechanism, and preferably the surroundings thereof. Instead of orienting, capturing and identifying the mechanism, a reference indication can also be captured and identified, which contains a predetermined position and orientation with respect to the mechanism, such that said sub-steps can also be executed using the reference indication, as will be described further below in relation to initializing the method.

In other words, for example, the user orients the tablet or the HoloLens, for instance, towards a robot that they wish to program. The robot is captured stereoscopically by means of the area scan camera, for example, and is identified in the captured image data by means of image processing methods. At the same time, three-dimensional locational data on the robot, its foundation and the rest of the surroundings are obtained. By means of the three-dimensional indication, positions and preferably poses can be assigned to the robot in the three-dimensional space computed from the image data at the site where it is also actually located in the real-world surroundings. Preferably, the surroundings thereof can be captured at the same time, and objects and a foundation can be identified. As a result, a three-dimensional map of the surroundings of the robot can be created. Subsequently, by means of superimposition, the virtual representation of the robot and any virtual representations of further objects can be overlaid in the real-world view at the site where the corresponding real-world robot is located. This applies accordingly to all other objects.

A three-dimensional map of the surroundings of the robot can thus be applied. This map can also be based on the captured image data that are related to the image capturing element of the mobile display apparatus and, if applicable, an image capturing unit of the mechanism, as will be described further below. In this respect, at least one division into free regions and non-free regions can be carried out, since on this basis at least one collision identification can take place, as will be described further below; moreover, there may be regions on which there is no information since images of these regions have not yet been captured. This can simplify and thus, for example, speed up the image processing, Preferably, the non-free regions are distinguished more precisely such that specific objects can be identified. Images of the surroundings are captured as part of the capture of a detail of the surroundings to the extent permitted by the image capturing range of the image capturing unit,

This can be done in particular by taking account of the geometric relationships of the multi-link actuated mechanism, e.g. of the robot, in the overlaying. As described above, due to the assignment of the virtual representation in combination with the real-world objects in a common three-dimensional space, each virtual representation is arranged and accordingly displayed at the correct position and in the correct orientation relative to the user or to the mobile display apparatus with respect to the rest of the objects. As a result, the objects can then only obscure one another if they are accordingly arranged one behind the other in the three-dimensional space with respect to the user or to the mobile display apparatus. A virtual representation of an object is thus shown only if, in that position, it would also be visible to the user in an unobstructed manner in the real-world surroundings.

Applied to the multi-link actuated mechanism, this means that, when the individual links are oriented identically, the virtual representation of the multi-link actuated mechanism is not displayed at all so as to not obscure the real-world multi-axis actuated mechanism from the user and thereby make the use more difficult. The portion of the virtual representation of the multi-link actuated mechanism that projects beyond the real-world multi-link actuated mechanism is shown only when the virtual representation of the multi-link actuated mechanism is spatially distinguished from the real-world multi-link actuated mechanism, for example due to a simulated movement. If, in the process, the virtual representation of the multi-link actuated mechanism is, for example, moved away from the user, i.e. it is located behind the real-world multi-link actuated mechanism relative to the user, only the portion of the virtual representation of the multi-link actuated mechanism that would be visible to the user past the real-world multi-link actuated mechanism in the real-world surroundings is shown.

Overlayings according to the invention that take account of the geometric relationships can thus ensure spatially correct overlaying, such that e.g. obscuring of the real-world surroundings by virtual objects and vice versa can be displayed, as would be the case with real-world objects with respect to one another. For example, further away virtual objects can be obscured by a real-world object or “disappear” behind them; this can be made possible by a depth rendering between real-world and virtual objects that may depend on the perspective of the user, which can be computed from the self-locator function of the mobile display apparatus.

As a result, despite the overlaying of virtual objects the correct depth perception is retained for the user since the virtual representations are inserted into the representation of the real-world surroundings. This can enable an intuitive and/or efficient use of the multi-link actuated mechanism, e.g. during commissioning and programming with minimal user interaction. Less mental effort may also be required for the transfer procedure between, for example, the programming and the expected behavior of the multi-link actuated mechanism in its real-world surroundings.

In other words, previously the virtual display was often overlaid without taking account of the real-world object or the real-world scene. Where, for example, the programming of robots is viewed in an augmented reality, up to now it has been common for the virtual representation of the robot to frequently obscure the real-world robot upon superimposition, and so the user may lose the reference to the real-world robot and its surroundings. Virtually displayed objects behind the real-world robot or behind objects often also obscure the real-world object from the point of view of the user, as a result of which the depth impression or depth perception is restricted. According to the invention, this can be prevented.

The overlaying can also be done through the use of or through the merging of heterogeneous sensor data of the multi-link actuated mechanism, e.g. axis data, performance data, planning data. Objects and obstacles in the working space of the multi-link actuated mechanism that can be identified from the captured image data can also be taken into account. As described above, this can further improve the overlaying.

These method steps can be executed in their entirety by the multi-link actuated mechanism, and the merged data can be transmitted to the mobile display apparatus to be displayed. The method steps can also be executed in their entirety by the mobile display apparatus, which, where applicable, can receive data from the multi-link actuated mechanism for this purpose. The method steps can also be executed in part by the mobile display apparatus and in part by the multi-link actuated mechanism. In each case, the method steps of the multi-link actuated mechanism can be executed by the control unit thereof, e._{g}. the motion control system.

Communication with exchange of data, such as for the sensor data, can occur in just one direction or in both directions via corresponding data/communication interfaces and a data line, e.g. ethernet, field bus system and the like. The data can be simultaneously made available via the communication interfaces of the relevant arithmetic unit.

According to one aspect of the present invention, the method comprises at least the further step of:
indicating, by the user, a first point, preferably a first pose, by means of the mobile display apparatus,

a virtual representation of the first point, preferably the first pose, being overlaid for the user in the display element of the mobile display apparatus,

preferably comprising at least the further step of:
indicating, by the user, a second point, preferably a second pose, by means of the mobile display apparatus,

a virtual representation of the second point, preferably the second pose, being overlaid for the user in the display element of the mobile display apparatus.

In this way, the user can select at least one point, preferably a pose, in the space, preferably in Cartesian coordinates, and specify it for the method. This can preferably be done while taking into account the configuration of the multi-link actuated mechanism, such that a first pose and/or a second pose can be specified. By means of the virtual representation of the point or pose, this specifying can be simplified for the user. The result can also be optically checked.

According to another aspect of the present invention, the method comprises at least the further step of:
selecting, by the user, a first object by means of the mobile display apparatus,

a virtual representation of the selection of the first object being overlaid for the user in the display element of the mobile display apparatus,

preferably comprising at least the further step of:
selecting, by the user, a second object by means of the mobile display apparatus,

a virtual representation of the selection of the second object being overlaid for the user in the display element of the mobile display apparatus,

This aspect of the present invention is based on the notion of further simplifying the use, and in particular the commissioning and/or programming for the user, in that no positions or poses need creating and assigning to an object by the user, but rather this is left to the multi-link actuated mechanism. As a result, just one object can be selected, and the mechanism can automatically determine a position or pose in order to reach that object. For example, the first object can be an item to be gripped, and the second object can be the location where that item is to be set down. This can be particularly intuitive for the user, can accordingly speed up the use and make it be less error-prone.

According to another aspect of the present invention, the selection comprises the sub-steps of:
orienting, by the user, the image capturing element of the mobile display apparatus towards the first object or towards the second object,
capturing the first object or the second object by means of the image capturing element of the mobile display apparatus, and
marking the first object or the second object in the display element of the mobile display apparatus,
preferably also confirming, by the user, that the first object or the second object is to be selected.

In other words, the mobile display apparatus can be oriented towards the object such that the object can be optically captured and identified. This can be done, for example, by using the center point of the mobile display apparatus as a cursor or crosshair and preferably also virtually displaying it accordingly, such that the user can “home in” on the object they wish to select. If the mechanism has its own image capturing unit, the image data thereof can additionally be used to optically capture and identify the object if the object is located in the image capturing range of that image capturing unit.

The targeted object can now be selected through operation by the user by, for example, leaving the cursor pointed at the object for a few seconds. If this is identified, the object can, for example, be labelled as selectable by a virtual representation, e.g. a colored border, possibly also a flashing border, around the object. This is either actively confirmed by the user or indirectly confirmed by said object continuing to be targeted further for a few additional seconds, for example; in this way, that object can be understood as being to be selected. This can be symbolized by a different marker, e.g. in a different color or by a continuous border (no flashing).

According to another aspect of the present invention, the method comprises at least the further steps of:
creating at least one trajectory between a start pose and a target pose,

the start pose being the current pose of the end effector of the multi-link actuated mechanism, and the target pose being the first point, preferably the first pose, and/or

the start pose being the first point, preferably the first pose, and the target pose being the second point, preferably the second pose, or vice versa, or

the start pose being the current pose of the end effector of the multi-link actuated mechanism, and the target pose being the first object, and/or

the start pose being the first object and the target pose being the second object, or vice versa, and
travelling along the trajectory by means of the virtual representation of the multi-link actuated mechanism.

A trajectory can be created using known methods for trajectory planning. As already explained above, the trajectory is then travelled along by overlaying the virtual representation of the multi-link actuated mechanism wherever it is not obscured by the multi-link actuated mechanism. This can allow the user to view the result of their programming in the real-world surroundings in a virtual representation that enables correct depth perception.

According to another aspect of the present invention, the method comprises at least the further step of:
identifying a collision of the virtual representation of the multi-link actuated mechanism with a real-world collision object by comparing the captured surroundings with the movement of the virtual representation of the multi-link actuated mechanism,

a virtual representation of the collision being overlaid for the user in the display element of the mobile display apparatus, and preferably, in response to an identified collision, stopping the movement of the virtual representation of the multi-link actuated mechanism.

Since, as explained above, a three-dimensional assignment of all the objects identified from the image data is also available for the surroundings of the multi-link actuated mechanism in the form of a surroundings map, in relation to the trajectory it can also be identified from this information if the virtual representation of the multi-link actuated mechanism virtually collides with a depiction of a real-world object. For simplification, a distinction can be made between free regions and non-free regions, such that a collision of the mechanism with a non-free region can be identified. This can make it possible to virtually test the trajectory for collisions.

In this case, a virtual representation of the collision can be overlaid for the user in order to inform them of it. In the process, the movement of the virtual representation of the multi-link actuated mechanism is preferably stopped in order to display the location to the user and give them the opportunity to rectify the cause of the collision, e.g. by altering the trajectory.

According to another aspect of the present invention, the method comprises at least the further step of:
in response to an identified collision, marking at least one portion of the virtual representation of the multi-link actuated mechanism,
preferably marking the virtual representation of the multi-link actuated mechanism in portions where the collision has occurred.

As a result, the attentiveness of the user for the collision per se, and in particular for the specific location of the collision on the multi-link actuated mechanism, can be increased. This can make it simpler for the user to search for the cause of the collision, in particular by the collision site being marked.

According to another aspect of the present invention, the method comprises at east the further steps of:
creating at least one alternative trajectory between at least the start pose and the target pose, and
travelling along the alternative trajectory by means of the virtual representation of the multi-link actuated mechanism.

This step can be automatically implemented, for example, by the multi-link actuated mechanism, preferably following a request or confirmation from the user. This can be assisted by the three-dimensional data on the surroundings of the mechanism, since the position of the objects in the surroundings of the mechanism in the real-world space is known. A trajectory that can bypass the site of the collision can thus be determined by the mechanism itself. As described above, this can be verified by travelling along the altered trajectory virtually.

According to another aspect of the present invention, the method comprises at least the further steps of:
indicating, by the user, a further point, preferably a further pose, by means of the mobile display apparatus,

a virtual representation of the further point, preferably the further pose, being overlaid for the user in the display element,
creating at least one alternative trajectory between a start pose and a target pose while taking account of the further point, preferably the further pose, and
travelling along the trajectory by means of the virtual representation of the multi-link actuated mechanism.

As a result, the user can alter the trajectory in order to bypass the site where the collision has occurred. As described above, this can be verified by travelling along the altered trajectory virtually.

According to another aspect of the present invention, the method comprises at least the further step of:
travelling along the trajectory by means of the multi-link actuated mechanism.

If the trajectory has been successfully travelled along virtually with no collisions, the transmission to the real-world mechanism can take place.

According to another aspect of the present invention, the method comprises, prior to the overlaying, at least the further steps of:
initializing the method,

preferably at least the sub-steps of:
creating the virtual representation of the multi-link actuated mechanism,
orienting the virtual representation of the multi-link actuated mechanism on the basis of the poses of the links and/or the actuated joints and/or the end effector of the multi-link actuated mechanism,
capturing the multi-link actuated mechanism and/or a reference indication of the multi-link actuated mechanism, and
referencing the virtual representation of the multi-link actuated mechanism to the multi-link actuated mechanism on the basis of the captured multi-link actuated mechanism or on the basis of the reference indication.

On the basis of the design of the multi-link actuated mechanism, for example, a model can be created that can be used for the virtual representation, Further data on the real-world mechanism, such as the joint positions, can be used to orient the individual links of the virtual model according to the current configuration of the real-world mechanism. As a result, a virtual representation of the mechanism can be created that corresponds to the current state of the mechanism. To arrange this virtual representation of the mechanism in the space in accordance with the real-world mechanism, the real-world mechanism can be identified, for example, from the image data, and the virtual representation can be superimposed thereon. A marker or the like can also be used as a reference indication, the distance and orientation of which relative to the real-world mechanism are known. This reference indication can be identified from the image data, and the virtual representation of the mechanism can be displaced relative to the reference indication and then superimposed on the real-world mechanism by means of the displacement vector known therefrom. As a result, the virtual representation of the mechanism is referenced with respect to the real-world mechanism.

According to another aspect of the present invention, the indicating, the selecting and/or the confirming by the user are carried out by means of at least one operator input by the user, the operator input of the user preferably being overlaid in the display element as a virtual representation, the operator input of the user preferably being a gesture that is captured by the image capturing element of the mobile display apparatus or a touch that is captured by the display element of the mobile display apparatus. Gestures of this kind, in particular with the fingers, such as closing the fingers over a virtually represented control element, can be implemented very simply and intuitively for the user. Furthermore, the operation of, for example, a touch-sensitive screen, e.g. of a tablet, is known to users nowadays and can be implemented intuitively. By means of the virtual representation of the operator input identified by the mobile display apparatus, the user can verify whether the identified operator input corresponds to the operator input actually made.

According to another aspect of the present invention, the multi-link actuated mechanism further comprises at least one image capturing unit, which is arranged and oriented so as to capture at least the surroundings in front of the end effector, the image capturing unit preferably being arranged and oriented on the end effector or on an end-effector unit so as to capture the surroundings immediately in front of the end effector, the method being carried out while also taking account of the image data of the image capturing unit of the multi-link actuated mechanism. This can improve the possibilities for creating three-dimensional data.

In particular, image capturing elements that can be used to capture as large a detail as possible of the surroundings of the mobile display apparatus are typically used for mobile display apparatuses. This can be detrimental to the quality of the image capturing, i.e. the captured image data have a comparatively low image resolution and so the mechanism and objects in its surroundings cannot be reliably identified. Image capturing elements, e.g. srnartphones, tablets and in particular a HoloLens, may also have a very low surface area and/or a very low weight, which miniaturizes them and thus can also restrict their performance. This deficiency can be compensated for at least for the region that can be captured by an image capturing unit of the multi-link actuated mechanism since a considerably larger, heavier and also more powerful image capturing unit can be used as the image capturing unit for a mechanism. In addition, the image capturing unit can be moved considerably closer to the mechanism and its immediate surroundings. Each of these alone, and in particular in combination, can increase the resolution at least in the image capturing range of the image capturing unit of the mechanism.

According to another aspect of the present invention, at least one virtual representation contains at least one piece of information that is overlaid in the display element of the mobile display apparatus, the virtual representation preferably comprising at least the following:
a control element for interaction with the user, preferably by means of at least one operator input, and/or
a coordinate system of the end effector, and/or
a coordinate system of at least one point, preferably of at least one pose, and/or
a trajectory, and/or
a duration of a trajectory, and/or
a total length of a trajectory, and/or
the energy requirement for a trajectory, and/or
the image capturing range of an image capturing unit of the multi-link actuated mechanism, and/or
a singularity of the multi-link actuated mechanism, and/or
a boundary of the working space of the multi-link actuated mechanism, and/or
a boundary of the articulation space of the multi-link actuated mechanism, and/or
a predetermined limit of the multi-link actuated mechanism, and/or
an instruction to the user.

Each of these pieces of information, and in particular a plurality of these pieces of information in combination, can simplify and/or speed up the use and/or make it more intuitive.

The present invention also relates to a system for the use, by a user, of a multi-link actuated mechanism, preferably a robot, particularly preferably an articulated robot, by means of a mobile display apparatus, the multi-link actuated mechanism comprising at least:
a plurality of links interconnected by actuated joints, and
an end effector connected to at least one link,

the mobile display apparatus comprising at least:
at least one display element designed to display to the user at least one real-world representation of the multi-link actuated mechanism, preferably together with the surroundings thereof, and
at least one image capturing element designed to capture the multi-link actuated mechanism, preferably together with the surroundings thereof, as image data together with depth information,
the display element further being configured to overlay, for the user, at least one virtual representation of the multi-link actuated mechanism on the real-world representation of the multi-link actuated mechanism, and preferably in the surroundings thereof,

the system, preferably the multi-link actuated mechanism and/or the mobile display apparatus, being configured to carry out a method as described above, the multi-link actuated mechanism preferably further comprising at least one image capturing unit, which is arranged and oriented so as to capture at least the surroundings in front of the end effector, the image capturing unit preferably being arranged and oriented on the end effector or on an end-effector unit so as to capture the surroundings immediately in front of the end effector. The properties and advantages of a system of this kind or its components have already been described above with reference to the method according to the invention and will not be repeated here.

The present invention also relates to a mobile display apparatus for use in a system as described above, comprising at least one display element designed to display to the user at least one real-world representation of the multi-link actuated mechanism, preferably together with the surroundings thereof, and comprising at least one image capturing element designed to capture the multi-link actuated mechanism, preferably together with the surroundings thereof, as image data together with depth information, the display element further being configured to overlay, for the user, at least one virtual representation of the multi-link actuated mechanism on the real-world representation of the multi-link actuated mechanism, and preferably in the surroundings thereof, and the mobile display apparatus being configured to carry out a method as described above. The properties and advantages of a mobile display apparatus of this kind or its elements have already been described above with reference to the method according to the invention and will not be repeated here.

The present invention also relates to a multi-link actuated mechanism for use in a system as described above, comprising a plurality of links interconnected by actuated joints, and comprising an end effector connected to at least one link, the multi-link actuated mechanism being configured to carry out a method as described above, the multi-link actuated mechanism preferably further comprising at least one image capturing unit, which is arranged and oriented so as to capture at least the surroundings in front of the end effector, the image capturing unit preferably being arranged and oriented on the end effector or on an end-effector unit so as to capture the surroundings immediately in front of the end effector. The properties and advantages of a multi-link actuated mechanism of this kind or its elements have already been described above with reference to the method according to the invention and will not be repeated here.

The present invention also relates to a computer program product comprising a program code stored on a computer-readable medium, for carrying out a method as described above. The computer-readable medium can be an internal memory of a computer or a removable memory such as a floppy disc, a CD, a DVD, a USB stick, a memory card and the like. A computer should be taken to mean any arithmetic unit able to carry out the method. In this way, the method according to the invention can be made available to a computer, which may be a control unit of an apparatus according to the invention.

Two embodiments and further advantages of the invention will be explained below in relation to the following drawings, in which:

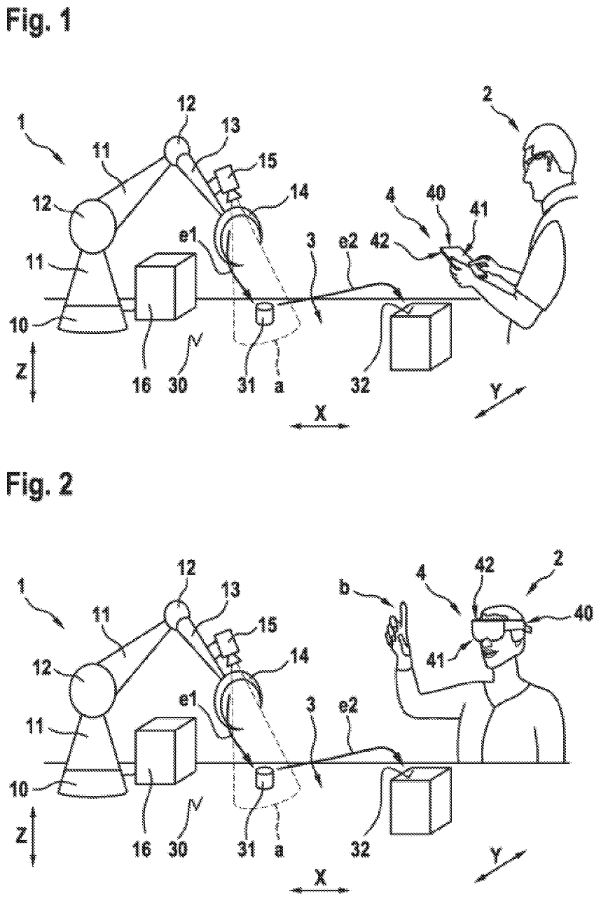

FIG. 1 is a schematic perspective view of a system according to the invention in accordance with a first example embodiment;

FIG. 2 is a schematic perspective view of a system according to the invention in accordance with a second example embodiment;

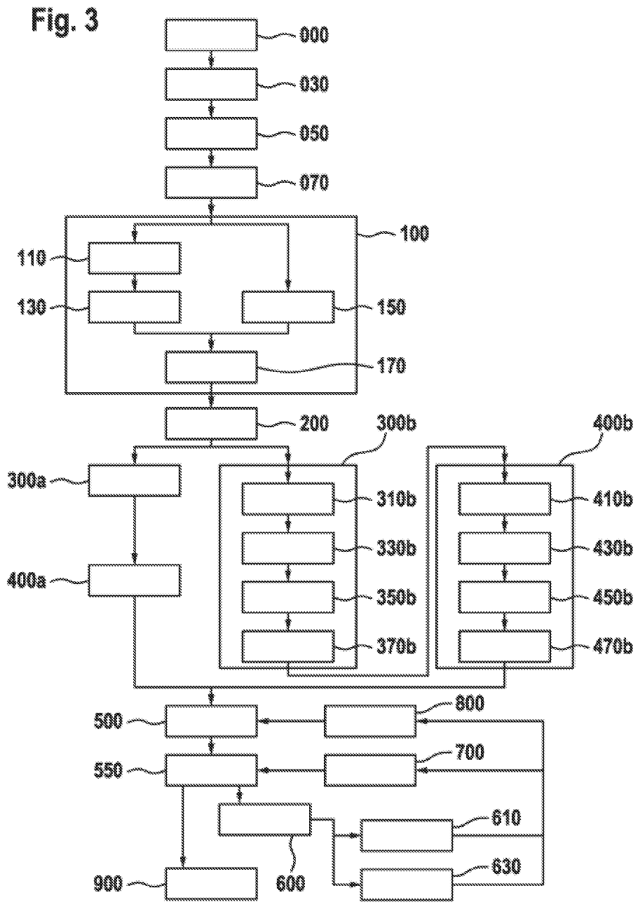

FIG. 3 is a flow diagram of a method according to the invention; and

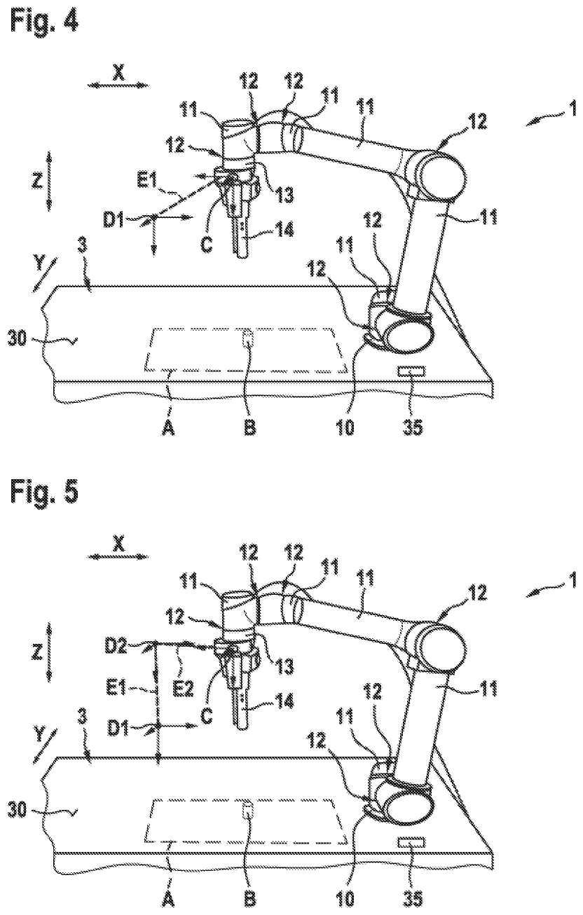

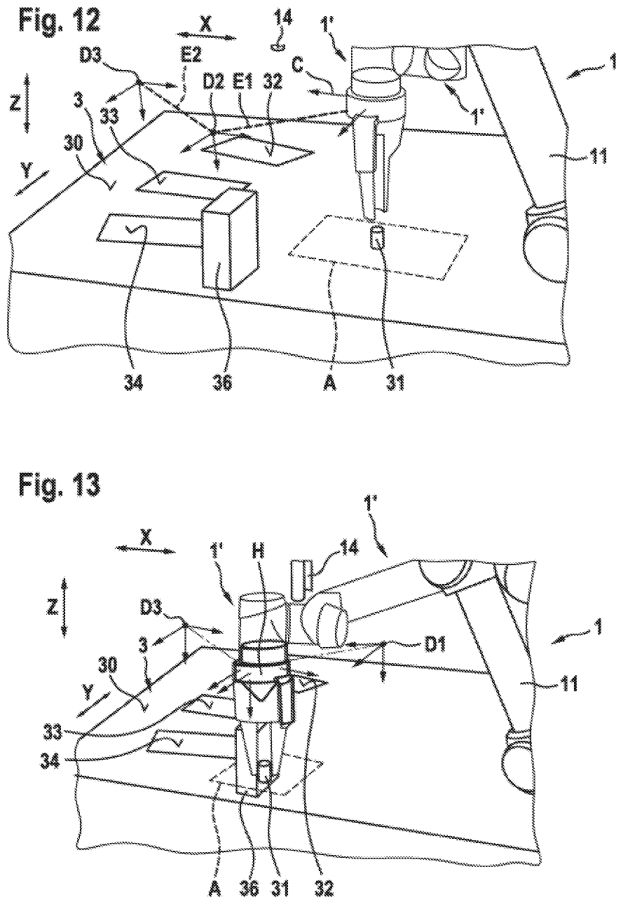

FIGS. 4 to 13 are various schematic perspective views of a multi-link actuated mechanism according to the invention in various method steps.

The above-mentioned figures are viewed in Cartesian coordinates. There is a longitudinal direction X, which can also be referred to as the depth X. Perpendicular to the longitudinal direction X is a transverse direction Y, which can also be referred to as the width Y. Perpendicular to both the longitudinal direction X and the transverse direction 1′ is a vertical direction Z, which can also be referred to as the height Z.

FIG. 1 is a schematic perspective view of a system 1, 4 according to the invention in accordance with a first example embodiment. The system 1, 4 comprises a multi-link actuated mechanism 1, which in these two example embodiments is configured as a robot 1, and more specifically an articulated robot 1. The articulated robot 1 is arranged in a stationary manner on a foundation 3 or a foundation surface 30 by means of a base 10. A plurality of links 11 extend from the base 10 as a serial kinematic chain and are interconnected by actuated joints 12 in the form of actuated pivot joints 12. The final link 11 is connected to an end-effector unit 13 by means of an actuated pivot joint 12, said end-effector unit comprising an end effector 14 in the form of a gripper 14. The articulated robot 1 comprises a control unit 16, which can also be referred to as an arithmetic unit 16, a main computer 16 or a motion control system 16. An image capturing unit 15 is arranged on the end-effector unit 13, oriented axially in the direction of the end effector 14, and can capture images of the surroundings of the articulated robot 1 immediately in front of the end effector 14 by means of its image capturing range a. This image capturing may contain depth information since the image capturing unit 15 of the end effector 14 is configured as a stereoscopic area scan camera.

On the foundation surface 30, a first object 31 is arranged in the form of an item 31 that can be gripped by an articulated robot 1 using its end effector 14 and set down on a second object 32 in the form of a first set-down surface 32. For this purpose, the articulated robot 1 can travel towards the item along a first trajectory e1, grip the item, and move it along a second trajectory e2 towards the first set-down surface 32, where it sets the item down.

To program this “picking and placing” application, a user 2 uses a mobile display apparatus 4 in the form of a tablet 4. The tablet 4 has a holder element 40 in the form of a casing 40, which encloses the edges and underside of the tablet 4. A user 2 can hold the tablet 4 on the side with at least one hand via the casing 40. On its top face, the tablet 4 has a display element 41 in the form of a screen facing the user 2,

On the opposite side of the tablet 4 at the upper edge of the rim of the casing 40, the tablet 4 further comprises an image capturing element 42 in the form of a stereoscopic area scan camera. Using the image capturing element 42, images, in this case of the articulated robot 1 and its surroundings, can be captured and can also contain depth information due to the stereoscopic characteristic of the image capturing element 42. The captured image data can also be displayed to the user 2 by the display element 41, such that thereon the user can see an image of what they pointed the tablet 4 or its image capturing element 42 at. In addition to the captured real-world image data, which can simply be rendered by the display element 41, additional virtual representations can be displayed, as will be described in more detail below.

FIG. 2 is a schematic perspective view of a system 1, 4 according to the invention in accordance with a second example embodiment. In this case, the user 2 is using mixed-reality glasses 4 instead of a tablet 4. Accordingly, the temples are formed as the holder elements 40. The image capturing element 42 is arranged between the two eyeglass lenses and is pointed directly away from the user 2. The two eyeglass lenses are transparent and are thus used as the display element 41 since the user 2 can optically capture the articulated robot 1 directly through the display element 41. By means of the display element 41, additional virtual representations can also be displayed, as will be described in more detail below.

FIG. 3 is a flow diagram of a method according to the invention. FIGS. 4 to 13 are various schematic perspective views of a multi-link actuated mechanism 1 according to the invention in various method steps, using a mobile display apparatus 4 in accordance with the second example embodiment as a HoloLens 4.

The user 2 orients 000 the image capturing element 42 of the mobile display apparatus 4 towards the articulated robot 1 together with the surroundings thereof; see FIGS. 1 and 2.

The articulated robot 1 together with the surroundings thereof is captured 030 by means of the image capturing element 42 of the mobile display apparatus 4, images being captured of the detail of the surroundings that at that moment can be captured by the image capturing element 42 due to the orientation carried out by the user 2.

The articulated robot 1 and the surroundings thereof are identified 050 in the captured image data of the image capturing element 42 of the mobile display apparatus 4. This can be done by means of known image processing and pattern detection methods.

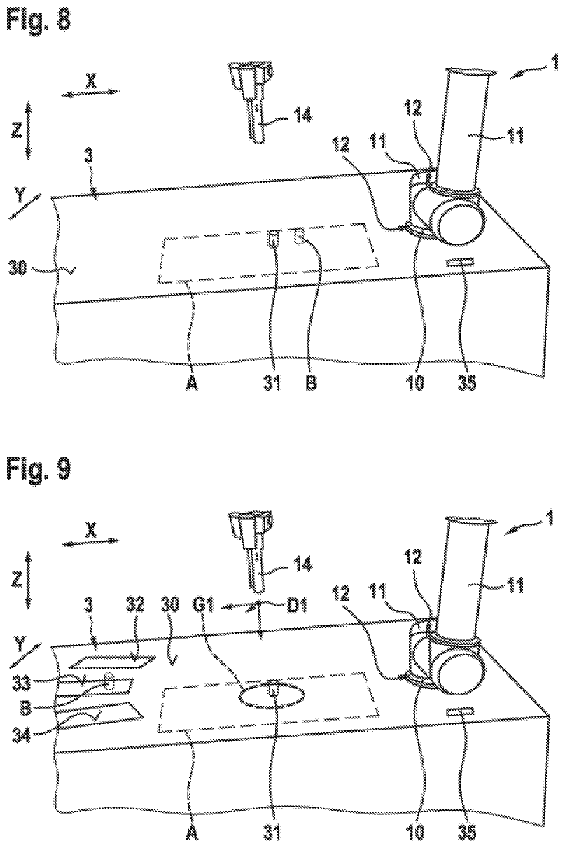

The articulated robot 1 and the surroundings thereof are indicated 070, in three dimensions, on the basis of the captured image data together with the depth information. In this case, the depth information is made available by the image capturing element 42 in the form of a stereoscopic area scan camera. The indicating 070 of the articulated robot 1 and of objects 31-34 in the surroundings thereof in three dimensions (see FIGS. 8 and 9) provides a three-dimensional surroundings map. Objects 31 located in the image capturing range of the image capturing unit 15 of the end effector 14 of the articulated robot 1 are also optically captured by said image capturing unit, which can improve the quality of the identification 050 and indication 070 thereof, due to the relatively great spatial proximity to the object 31, and of the resolution of the image capturing unit 15 of the end effector 14 of the articulated robot 1.

The method is initialized 100; this has to be carried out just once before the method is used for the current operation, and preferably comprises a plurality of sub-steps. The virtual representation of the articulated robot 1 is thus created 110 on the basis of a kinematic model corresponding to the design of the corresponding real-world articulated robot 1. The virtual representation of the articulated robot 1′ is oriented 130 on the basis of the poses of the links 11 or the actuated joints 12 and the end effector 14 of the articulated robot 1 such that the real-world articulated robot 1 and its virtual representation match. In the process, for example, the angular positions of the joints 12 of the real-world articulated robot 1 are taken into account; they are captured by sensor and thus made available.

A reference indication 35 of the articulated robot 1 is captured 150 in the form of an optical marker 35, which is arranged in the immediate vicinity of the base 10 of the articulated robot 1 on the foundation surface 30 of the foundation 3 and is located, when the image capturing element 42 of the mobile display apparatus 4 is in this orientation, in the image capturing range of the image capturing element 42 thereof. Alternatively, the articulated robot 1 itself could also be identified, but the capturing and identification of an optical marker 35 may be simpler to implement.

The virtual representation of the articulated robot is referenced 170 to the real-world articulated robot 1 on the basis of the captured optical marker 35. In other words, the virtual representation of the articulated robot 1′ is displaced onto the real-world articulated robot 1 such that they correspond to each other; the links 11, joints 12 and end effector 14 have already been oriented relative to one another in the initial orientation 130.

The virtual representation of the articulated robot 1′, and in the surroundings thereof, is overlaid 200 on the real-world articulated robot 1 in the display element 41 of the mobile display apparatus 4. In other words, the data on the virtual surroundings and the real-world surroundings are merged together or superimposed on one another. In the process, the overlaying 200 is carried out while taking account of the geometric relationships of the articulated robot 1 and the surroundings thereof. As a result, the depth information of the three-dimensional surroundings map can be incorporated into the overlaying such that the articulated robot 1 and other objects 31-34 can be displayed in the correct position and the correct orientation. This can prevent virtually displayed bodies from obscuring real-world bodies and can make the augmented reality thus created more comprehensible for the user 2. In particular, this can make commissioning and programming more intuitive for the user.

A first pose is indicated 300a by the user 2 by means of the mobile display apparatus 4, a virtual representation of the first pose D1 being overlaid for the user 2 in the display element 41 of the mobile display apparatus 4; see e.g. FIG. 4. A second pose is indicated 400a by the user 2 by means of the mobile display apparatus 4, a virtual representation of the second pose D2 being overlaid for the user 2 in the display element 41 of the mobile display apparatus 4; see e.g. FIG. 5. In this case, the second pose D2 is located between the end effector 14 of the articulated robot 1 (represented by pose C thereof) and the first pose D1. In this case, all the poses C, D1, D2 are displayed by means of Cartesian coordinate systems.

A trajectory e1, e2 is created 500 between the current pose of the end effector 14 (as the start pose) and the first pose D1 (as the target pose) via the second pose D2 (as the intermediate pose), this overall trajectory being divided into a first (sub-)trajectory e1 between the current pose of the end effector 14 and the second pose D2, and into a second (sub-)trajectory e2 between the second pose 02 and the first pose D1; see e.g. FIG. 5. Virtual representations E1, E2 of the trajectory e1, e2 are displayed to the user 2 by the display element 41 of the mobile display apparatus 4.

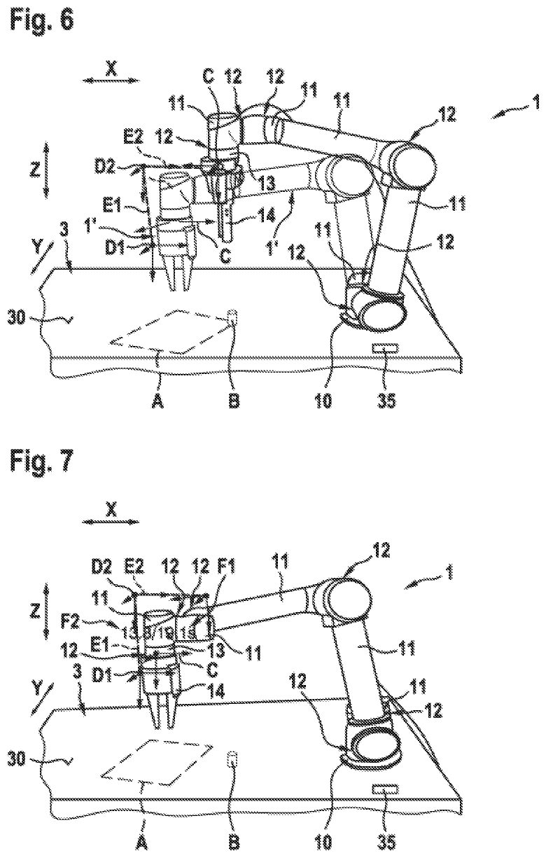

The trajectory e1, e2 is travelled along 550 by means of the virtual representation of the articulated robot 1′; see e.g. FIG. 6. In the process, no collision between the virtual representation of the articulated robot 1′ and the real-world surroundings or the depiction thereof as the three-dimensional surroundings map is identified; to simplify and speed up the corresponding calculations, all that matters for this is that the trajectory e1, e2 runs through free regions of the three-dimensional surroundings map.

Since this trajectory e1, e2 is optically followed by the user 2 and is assessed as being permitted for want of any collision, the trajectory e1, e2 can then be travelled along 900 by means of the real-world articulated robot 1. The user 2 is displayed a virtual representation of a duration F1 and the total length F2 of the trajectory e1, e2 by the display element 41 of the mobile display apparatus 4. The programming of this movement has thus been successfully completed.

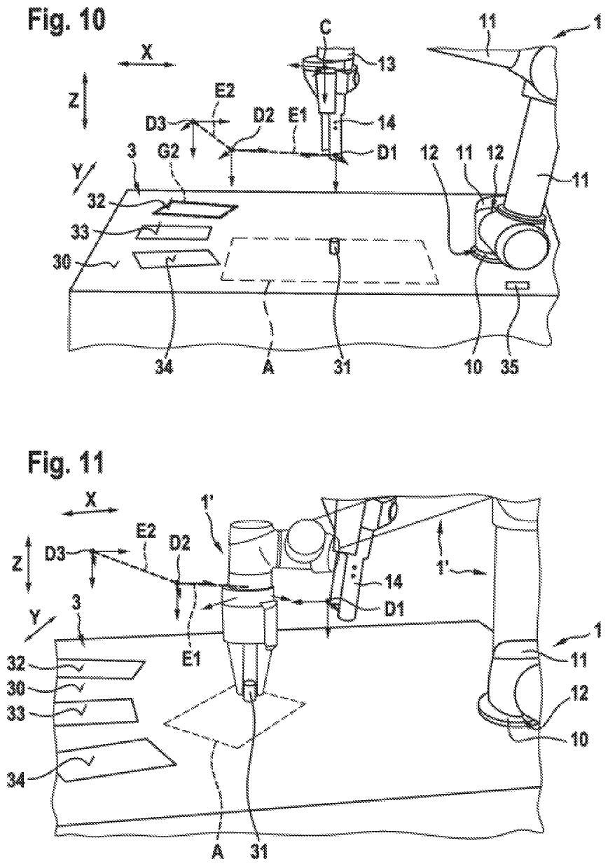

Alternatively, the user 2 selects 300b a first object 31 and selects 400b a second object 32 by means of the mobile display apparatus 4 in that the user 2 orients 310b; 410b the image capturing element 42 of the mobile display apparatus 4 towards the first object 31 or towards the second object 32, respectively; see e.g. FIG. 8 to 10. In the process, the first object 31 is an item 31 to be gripped by the end effector 14 of the articulated robot 1, and the second object 32 is a first set-down surface 32 out of three set-down surfaces 32-34 on which the item 31 is to be set down. The first object 31 or the second object 32 are captured 330b; 430b by means of the image capturing element 42 of the mobile display apparatus 4, The first object 31 or the second object 32 is marked 350b; 450b in the display element 41 of the mobile display apparatus 4 using colored highlighting; see e.g. FIGS. 9 and 10. The user 2 preferably also confirms 370a; 470a that the first object 31 or the second object 32 is to be selected, a gesture b being identified as the confirmation and a virtual representation of the gesture B being displayed to the user 2 by the display element 41 of the mobile display apparatus 4. Furthermore, a virtual representation of the selection G1 of the first object 31 and of a selection G2 of the second object 32 is overlaid for the user 2 in the display element 41 of the mobile display apparatus 4.

In this case too, at least one trajectory e1, e2 is now created 500 between a start pose and a target pose, said trajectory running from the current pose of the end effector 14 (represented by pose C thereof) to a third pose D3 via a first pose D1 and a second pose D2; the (sub-)trajectories e1, e2 run between the first pose D1 and the second pose D2 and between the second pose D2 and the third pose D3, respectively; see e.g. FIGS. 10 and 11.

The trajectory e1, e2 is travelled along 550 by means of the virtual representation of the articulated robot 1′, but in this case a collision object 36 is located along the first trajectory e1. A collision of the virtual representation of the articulated robot 1′ with the real-world collision object 36 is thus identified 600 by comparing the captured surroundings with the movement of the virtual representation of the articulated robot 1′, a virtual representation of the collision H being overlaid for the user 2 in the display element 41 of the mobile display apparatus 4. Furthermore, in response to the identified collision, the movement of the virtual representation of the articulated robot 1′ is stopped 610. Moreover, in response to the identified collision, the end effector 14 of the virtual representation of the articulated robot 1′ is marked 630 since the collision occurred in this portion of the virtual representation of the articulated robot 1′.

On one hand, at least one alternative trajectory e1, e2 can now be created 700 between at least the start pose and the target pose and can be executed automatically by the articulated robot 1. For instance, a further pose can be added to the trajectory e1 to bypass the real-world collision object 36.

The alternative trajectory e1, e2 is then travelled along 550 by means of the virtual representation of the articulated robot If this movement is collision-free, the trajectory e1, e2 can then be travelled along 900 by means of the real-world articulated robot 1. If this is successful, the programming of this movement has thus been successfully completed.

On the other hand, the user 2 can indicate 800 a further pose by means of the mobile display apparatus 4, a virtual representation of the further pose being overlaid for the user 2 in the display element 41. This further pose can also be added to the trajectory e1 to bypass the real-world collision object 36. On the basis of this further pose, at least one alternative trajectory e1, e2 can be created 500 between a start pose and a target pose while taking account of the further pose. If this movement is collision-free, the trajectory e1, e2 can then be travelled along 900 by means of the real-world articulated robot 1. If this is successful, the programming of this movement has thus been successfully completed.

### LIST OF REFERENCE SIGNS (part of description)

a Image capturing range of the image capturing unit 15 of the mechanism 1

A Virtual representation of the image capturing range of the image capturing unit 15 of the mechanism 1

b Gesture by the user 2

B Virtual representation of a gesture by the user 2

C Virtual representation of a coordinate system of the end effector 14

D1 Virtual representation (of a coordinate system) of a first point or a first pose

D2 Virtual representation (of a coordinate system) of a further/second point or a further/second pose

D3 Virtual representation (of a coordinate system) of a further/third point or a further/third pose

e1 First trajectory

E1 Virtual representation of a first trajectory e1

e2 Second trajectory

E2 Virtual representation of a second trajectory e2

F1 Virtual representation of a duration of a trajectory e1, e2

F2 Virtual representation of a total length of a trajectory e1, e2

G1 Virtual representation of the selection of the first object 31

G2 Virtual representation of the selection of the second object 32

H Virtual representation of a collision

X Longitudinal direction; depth

Y Transverse direction; width

Z Vertical direction; height

1 Multi-link actuated mechanism; (articulated) robot

1′ Virtual representation of the multi-link actuated mechanism 1

10 Base

11 Links

12 Actuated (pivot) joints

13 End-effector unit

14 End effector; gripper

15 Image capturing unit

16 Control unit; arithmetic unit; main computer; motion control system

2 User

3 Foundation

30 Foundation surface

31 First object; item

32 Second object; first set-down surface

33 Third object; second set-down surface

34 Fourth object; third set-down surface

35 Reference indication; optical marker

36 Collision object

4 Mobile display apparatus; mixed-reality glasses; augmented reality glasses; HoloLens; contact lens; handheld device; tablet; smartphone

40 Holder element; casing; temple

41 Display element

42 Image capturing element

000 Orienting image capturing element 42 towards the mechanism 1 by the user 2

030 Capturing mechanism 1 by means of the image capturing element 42

050 Identifying mechanism 1 in the captured image data

070 Indicating mechanism 1 in three dimensions on the basis of the captured image data together with depth information

100 Initializing method

110 Creating virtual representation of the mechanism 1′

130 Orienting virtual representation of the mechanism 1′

150 Capturing mechanism 1 and/or reference indication 35

170 Referencing virtual representation of the mechanism 1′ to the mechanism 1

200 Overlaying virtual representation of the mechanism 1′ on the mechanism 1 in the display element 41

300a Indicating, by the user 2, a first point or first pose by means of the mobile display apparatus 4

300b Selecting, by the user 2, a first object 31 by means of the mobile display apparatus 4

310b Orienting, by the user 2, the image capturing element 42 towards the first object 31

330b Capturing first object 31 by means of the image capturing element 42

350b Marking first object 31 in the display element 41

370a Confirming, by the user 2, that the first object 31 is to be selected

400a Indicating, by the user 2, a second point or second pose by means of the mobile display apparatus 4

400b Selecting, by the user 2, a second object 32 by means of the mobile display apparatus 4

410b Orienting, by the user, the image capturing element 42 towards the second object 32.

430b Capturing second object 32 by means of the image capturing element 42

450b Marking second object 32 in the display element 41

470a Confirming, by the user 2, the second object 32 as to be selected

500 Creating trajectory e1, e2. between the start pose and target pose

550 Travelling along trajectory e1, e2 by means of the virtual representation of the mechanism 1

600 Identifying collision of the virtual representation of the mechanism 1′ with a real-world collision object 36

610 Stopping movement of the virtual representation of the mechanism 1′ in response to an identified collision

630 Marking portion of the virtual representation of the mechanism 1′ in response to an identified collision

700 Creating alternative trajectory e1, e2 between the start pose and target pose

800 Indicating, by the user 2, a further point or further pose by means of the mobile display apparatus 4

900 Travelling along trajectory e1, e2 by means of the mechanism 1

1. Method for the use, by a user, of a multi-link actuated mechanism, preferably a robot, particularly preferably an articulated robot, by means of a mobile display apparatus,
wherein the multi-link actuated mechanism comprises at least:
a plurality of links interconnected by actuated joints, and
an end effector connected to at least one link,
wherein the mobile display apparatus comprises at least:
at least one display element designed to display to the user at least one real-world representation of the multi-link actuated mechanism, preferably together with the surroundings thereof, and
at least one image capturing element designed to capture the multi-link actuated mechanism, preferably together with the surroundings thereof, as image data together with depth information,
wherein the display element is further configured to overlay, for the user, at least one virtual representation of the multi-link actuated mechanism on the real-world representation of the multi-link actuated mechanism, and preferably in the surroundings thereof,
comprising at least the steps of:
orienting, by the user, the image capturing element of the mobile display apparatus towards the multi-link actuated mechanism, preferably together with the surroundings thereof,
capturing at least the multi-link actuated mechanism, preferably together with the surroundings thereof, by means of the image capturing element of the mobile display apparatus,
identifying the multi-link actuated mechanism, and preferably the surroundings thereof, in the captured image data of the image capturing element of the mobile display apparatus,
indicating, in three dimensions, the multi-link actuated mechanism, and preferably in the surroundings thereof, on the basis of the captured image data together with the depth information, and
overlaying the virtual representation of the multi-link actuated mechanism, and preferably in the surroundings thereof, on the multi-link actuated mechanism in the display element of the mobile display apparatus,
wherein the overlaying is carried out while taking account of the geometric relationships of the multi-link actuated mechanism, and preferably the surroundings thereof.

2. Method according to claim 1, characterized by at least the further step of:
indicating, by the user, a first point, preferably a first pose, by means of the mobile display apparatus,
a virtual representation of the first point, preferably the first pose, being overlaid for the user in the display element of the mobile display apparatus,
preferably comprising at least the further step of:
indicating, by the user, a second point, preferably a second pose, by means of the mobile display apparatus,
a virtual representation of the second point, preferably the second pose being overlaid for the user in the display element of the mobile display apparatus.

3. Method according to claim 1, characterized by at least the further step of:
selecting, by the user, a first object by means of the mobile display apparatus,
a virtual representation of the selection of the first object being overlaid for the user in the display element of the mobile display apparatus,
preferably comprising at least the further step of:
selecting, by the user, a second object by means of the mobile display apparatus,
a virtual representation of the selection of the second object being overlaid for the user in the display element of the mobile display apparatus.

4. Method according to claim 3, characterized by at least the sub-steps of selecting:
orienting, by the user, the image capturing element of the mobile display apparatus towards the first object or towards the second object,
capturing the first object or the second object by means of the image capturing element of the mobile display apparatus, and
marking the first object or the second object in the display element of the mobile display apparatus,
preferably also confirming, by the user, that the first object or the second object is to be selected.

5. Method according to claim 2, characterized by at least the further steps of:
creating at least one trajectory between a start pose and a target pose,
the start pose being the current pose of the end effector of the multi-link actuated mechanism, and the target pose being the first point, preferably the first pose, and/or
the start pose being the first point, preferably the first pose, and the target pose being the second point, preferably the second pose, or vice versa, or
the start pose being the current pose of the end effector of the multi-link actuated mechanism, and the target pose being the first object, and/or
the start pose being the first object and the target pose being the second object, or vice versa, and
travelling along the trajectory by means of the virtual representation of the multi-link actuated mechanism.

6. Method according to claim 5, characterized by at least the further step of:
identifying a collision of the virtual representation of the multi-link actuated mechanism with a real-world collision object by comparing the captured surroundings with the movement of the virtual representation of the multi-link actuated mechanism,
a virtual representation of the collision being overlaid for the user in the display element of the mobile display apparatus,
and preferably, in response to an identified collision, stopping the movement of the virtual representation of the multi-link actuated mechanism.

7. Method according to claim 6, characterized by at least the further step of:
in response to an identified collision, marking at least one portion of the virtual representation of the multi-link actuated mechanism,
preferably marking the virtual representation of the multi-link actuated mechanism in portions where the collision has occurred.

8. Method according to claim 6, characterized by at least the further steps of:
creating at least one alternative trajectory between at least the start pose and the target pose, and
travelling along the trajectory by means of the virtual representation of the multi-link actuated mechanism.

9. Method according to claim 6, characterized by at least the further steps of:
indicating, by the user, a further point, preferably a further pose, by means of the mobile display apparatus,
a virtual representation of the further point, preferably the further pose, being overlaid for the user in the display element,
creating at least one alternative trajectory between a start pose and a target pose while taking account of the further point, preferably the further pose, and
travelling along the trajectory by means of the virtual representation of the multi-link actuated mechanism.

10. Method according to claim 5, characterized by at least the further step of:
travelling along the trajectory by means of the multi-link actuated mechanism.

11. Method according to claim 1, characterized by the steps, prior to the overlaying, of at least:
initializing the method,
preferably by at least the sub-steps of:
creating the virtual representation of the multi-link actuated mechanism
orienting the virtual representation of the multi-link actuated mechanism on the basis of the poses of the links and/or the actuated joints and/or the end effector of the multi-link actuated mechanism,
capturing the multi-link actuated mechanism and/or a reference indication of the multi-link actuated mechanism, and
referencing the virtual representation of the multi-link actuated mechanism to the multi-link actuated mechanism on the basis of the captured multi-link actuated mechanism or on the basis of the reference indication.

12. Method according to claim 1, characterized in that
the indicating, the selecting and/or the confirming by the user are carried out by means of at least one operator input by the user,
the operator input of the user preferably being overlaid in the display element as a virtual representation,
the operator input of the user preferably being a gesture that is captured by the image capturing element of the mobile display apparatus or a touch that is captured by the display element of the mobile display apparatus.

13. Method according to claim 1, characterized in that
the multi-link actuated mechanism further comprises at least one image capturing unit, which is arranged and oriented so as to capture at least the surroundings in front of the end effector,
the image capturing unit preferably being arranged and oriented on the end effector or on an end-effector unit so as to capture the surroundings immediately in front of the end effector,
the method being carried out while also taking account of the image data of the image capturing unit of the multi-link actuated mechanism.

14. Method according to claim 1, characterized by
at least one virtual representation of at least one piece of information that is overlaid in the display element of the mobile display apparatus,
the virtual representation preferably comprising at least:
a control element for interaction with the user, preferably by means of at least one operator input, and/or
a coordinate system of the end effector, and/or
a coordinate system of at least one point, preferably of at least one pose, and/or
a trajectory, and/or
a duration of a trajectory, and/or
a total length of a trajectory, and/or
the energy requirement for a trajectory, and/or
the image capturing range of an image capturing unit of the multi-link actuated mechanism, and/or
a singularity of the multi-link actuated mechanism, and/or
a boundary of the working space of the multi-link actuated mechanism, and/or
a boundary of the articulation space of the multi-link actuated mechanism, and/or
a predetermined limit of the multi-link actuated mechanism, and/or
an instruction to the user.

15. System for the use, by a user, of a multi-link actuated mechanism, preferably a robot, particularly preferably an articulated robot, by means of a mobile display apparatus,
wherein the multi-link actuated mechanism comprises at least:
a plurality of links interconnected by actuated joints, and
an end effector connected to at least one link,
wherein the mobile display apparatus comprises at least:
at least one display element designed to display to the user at least one real-world representation of the multi-link actuated mechanism, preferably together with the surroundings thereof, and
at least one image capturing element designed to capture the multi-link actuated mechanism, preferably together with the surroundings thereof, as image data together with depth information,
wherein the display element is further configured to overlay, for the user, at least one virtual representation of the multi-link actuated mechanism on the real-world representation of the multi-link actuated mechanism, and preferably in the surroundings thereof,
wherein the system, preferably the multi-link actuated mechanism and/or the mobile display apparatus, is configured to carry out a method according to claim 1,
wherein the multi-link actuated mechanism preferably further comprises at least one image capturing unit, which is arranged and oriented so as to capture at least the surroundings in front of the end effector,
wherein the image capturing unit is preferably arranged and oriented on the end effector or on an end-effector unit so as to capture the surroundings immediately in front of the end effector.

16. Mobile display apparatus for use in a system according to claim 15,
comprising at least one display element, which is designed to display to the user at least one real-world representation of the multi-link actuated mechanism, preferably together with the surroundings thereof, and
comprising at least one image capturing element, which is designed to capture the multi-link actuated mechanism, preferably together with the surroundings thereof, as image data together with depth information,
wherein the display element is further configured to overlay, for the user, at least one virtual representation of the multi-link actuated mechanism on the real-world representation of the multi-link actuated mechanism, and preferably in the surroundings thereof.

17. Multi-link actuated mechanism for use in a system according to claim 15,
comprising a plurality of links interconnected by actuated joints, and
comprising an end effector connected to at least one link,
wherein the multi-link actuated mechanism preferably further comprises at least one image capturing unit, which is arranged and oriented so as to capture at least the surroundings in front of the end effector,
wherein the image capturing unit is preferably arranged and oriented on the end effector or on an end-effector unit so as to capture the surroundings immediately in front of the end effector .

18. Computer program product comprising a program code stored on a computer-readable medium, for carrying out a method according to claim 1.
